(19) United States
(12) Patent Application Publication
(10) Pub. No.: US 2009/0288036 A1
(43) Pub. Date: Nov. 19, 2009

(54) MULTI-WINDOW DISPLAY APPARATUS, MULTI-WINDOW DISPLAY METHOD, AND INTEGRATED CIRCUIT

(76) Inventors: Kazuya Osawa, Kanagawa (JP); Masaki Horiuchi, Osaka (JP); Mitsuhiro Aso, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/094,667

(22) PCT Filed: Nov. 20, 2006
(86) PCT No.: PCT/JP2006/323090

§ 371 Date: May 22, 2008

(30) Foreign Application Priority Data
Dec. 22, 2005 (JP) 2005-369834

(51) Int. Cl. G06F 3/048

(52) U.S. Cl. 715/794

(57) ABSTRACT

A multi-window display apparatus capable of displaying a plurality of windows on a screen thereof is provided with means for, when a new window is displayed so as to be superimposed on a window which has already been displayed, displaying the new window without covering significant information as ranch as possible. Upon a display request of a new window, a display object priority comparison section (103) determines, based on information stored in a display object information management section (104), an area having a low display priority on a display device (106). A new window display position determination section (102) displays the new window so as to be superimposed on the area having the low display priority.

### TECHNICAL FIELD

The present invention relates to a multi-window display apparatus for concurrently displaying a plurality of windows, and more particularly, to a multi-window display apparatus for determining display positions of a plurality of windows which are displayed concurrently.

### BACKGROUND ART

Conventionally, when an information processor, which is equipped with a display device as typified by a CRT display and a liquid crystal display, for example, an electronic apparatus such as a personal computer, a workstation, a mobile phone, and the like, concurrently performs a plurality of displays on the display device thereof, the information processor generates a plurality of rectangular areas called windows in a display possible area of the display device, and performs each display for each window, thereby concurrently displaying the plurality of windows on the display device. A display device capable of concurrently displaying a plurality of windows as described above is referred to as a multi-window display apparatus.

In the multi-window display apparatus, in order to currently display a plurality of windows thereon, a new window is sometimes displayed so as to be superimposed on a window which has already been displayed.

However, when the new window is superimposed on the window which has already been displayed as described above, a part or the entirety of the window which has already been displayed is covered by the new window, thereby providing an invisible area to a user. Thus, there is a problem that visibility for the user is lowered.

In such a background, there has been known a technique in which in the multi-window display apparatus, a specific area on a screen is set in advance as a constantly-displayed area. When a window is newly displayed, the window is positioned so as not to be superimposed on the constantly-displayed area. When it is impossible to position the window so as not to be superimposed on the constantly-displayed area, the window is positioned so as to minimize an area of a superimposed portion. Thus, visibility for a user is prevented from being lowered (e.g. refer to Patent Document 1).
[Patent Document 1] Japanese Laid-Open Patent Publication No. 11-272382

### DISCLOSURE OF THE INVENTION

### Problems to be Solved by the Invention

However, for example, when an apparatus with a relatively small screen, such as a mobile phone, concurrently displays a plurality of windows, the windows are basically displayed so as to be superimposed on each other. Thus, it is hard to position the windows so as not to be superimposed on each other by a conventional configuration. In addition, in a mode in which an area which the user does not desire to cover is set as the constantly-displayed area so as not to be covered as much as possible, when a new window is displayed on an apparatus with a small screen in a state where a ratio of the constantly-displayed areas to the screen is large due to setting of a plurality of constantly-displayed areas, and the like, the new window has to be displayed so as to be superimposed on the constantly-displayed area. As a result, the area which the user does not desire to cover has to be covered, and hence there is a problem that an effect which prevents the visibility for the user from being lowered is not obtained.

The present invention has been made for solving such conventional problems, and an object thereof is to provide a multi-window display apparatus which is capable of preventing the visibility for the user from being lowered by, when a new window is displayed on a display device thereof on which windows have already been displayed, searching for an area having a lower display priority from information of the existing windows such as existence or nonexistence of a focus, and displaying the new window so as to be superimposed on the area having the low display priority.

### Solution to the Problems

The present invention is directed to a multi-window display apparatus for concurrently displaying a plurality of windows. To achieve the above objects, the multi-window display apparatus of the present invention comprises: a display device capable of displaying the plurality of windows; a display device control section for controlling an operation of the display device; a display object information management section for managing positions, sizes, and priorities of display objects, which are displayed on the display device; a window operation request reception section for receiving a display request of a new window; a display object priority comparison section for comparing, based on priority, the display objects which are managed by the display object information management section, and extracting a display object having a low display priority; and a new window display position determination section for, when the window operation request reception section receives the display request of the new window, obtaining, as an area having a low display priority, a display area of the display object which is extracted by the display object priority comparison section, and determining a display position of the new window, which is requested to be displayed, to be set on the obtained area.

By this configuration, the multi-window display apparatus is capable of displaying the new window so as to be superimposed on the display object having the low display priority among the display objects which are displayed at a time when the display request of the new window is received.

The multi-window display apparatus of the present invention further comprises a display layout change section for changing a display layout of the display object, which is extracted by the display object priority comparison section, so as to obtain a display area of the new window, which is requested to be displayed. The new window display position determination section determines the display position of the new window, which is requested to be displayed, to be set on the display area which is obtained by the display layout change section.

By this configuration, the multi-window display apparatus changes the layout of the display object having the low display priority among the display objects which are displayed at the time when the display request of the new window is received, thereby displaying the new window, which is requested to be displayed, on the area which is obtained by the layout change.

The display device may include a first display device and a second display device. In this case, the display layout change section may move, among display objects which are displayed on the first display device, the display object, which is extracted by the display object priority comparison section, onto the second display device, and may obtain, as an area for displaying the new window which is requested to be displayed, an area on the first display device where the display object, which is moved onto the second display device, is displayed before being moved.

By this configuration, the multi-window display apparatus displays, on the second display device, the display object having the low display priority among the display objects which are displayed on the first display device at the time when the display request of the new window is received, thereby displaying the new window, which is requested to be displayed, in the area on the first display device where the object having the low display priority has been displayed.

When the window operation request reception section receives the display request of the new window and a plurality of display objects are registered in the display object information management section, the display layout change section may switch display positions of the plurality of display objects so that areas of display objects each having a low display priority are located adjacent to each other, may set the areas of the switched display objects each having the low display priority to be a single area having a low display priority, and may obtain the single area as an area for displaying the new window which is requested to be displayed.

By this configuration, the multi-window display apparatus rearranges the display objects which are displayed at the time when the display request of the new window is received, and obtains continuous areas each having a low display priority, thereby displaying a window, which is newly displayed, so as to be superimposed on the obtained areas.

The multi-window display apparatus of the present invention may further comprise a display item size comparison section for, when the window operation request reception section receives the display request of the new window, comparing a size of the object having the low display priority, which is extracted by the display object priority comparison section, with a size of the new window, which is requested to be displayed. In this case, when if is determined by the display item size comparison section that the size of the new window, which is requested to be displayed, is larger than that of the object having the low display priority, which is extracted by the display object priority comparison section, and a plurality of display objects are registered in the display object information management section, the display layout change section switches display positions of the plurality of display objects so that areas of display objects each having a low display priority are located adjacent to each other, sets the areas of the switched display objects each having the low display priority to be a single area having a low display priority, and obtains the single area as the area for displaying the new window which is requested to be displayed.

By this configuration, the multi-window display apparatus confirms whether or not, at the time when the display request of the new window is received, there is an area having a low display priority, which has a size sufficient to display the new window therein. When the area does not has a sufficient size, the multi-window display apparatus rearranges the display objects being displayed, and obtains continuous areas each having a low display priority, thereby displaying the new window, which is requested to be displayed, so as to be superimposed on the obtained areas.

Preferably, the display objects which are displayed on the display device are windows.

Further, each component, which the above multi-window display apparatus comprises, can be taken as a method providing a series of processing for the multi-window display apparatus for concurrently displaying a plurality of windows on a display device thereof. In other words, the method comprises: in the multi-window display apparatus, a window operation request reception step of receiving a display request of a new window; a display object priority comparison step of, when receiving the display request of the new window, comparing, based on priority, display objects which are displayed on the display device, and extracting a display object having a low display priority; a new window display position determination step of obtaining, as an area having a low display priority, a display area of the display object which is extracted at the display object priority comparison step, and determining a display position of the new window, which is requested to be displayed, to be set on the obtained area; and a display device control step of controlling an operation of the display device so as to display the new window in the display position which is determined at the new window display position determination step.

The above method may further comprise a display layout change step of changing a display layout of the display object, which is extracted at the display object priority comparison step, so as to obtain a display area of the new window which is requested to be displayed. In this case, the new window display position determination step includes determining the display position of the new window, which is requested to be displayed, to be set on the display area which is obtained at the display layout change step.

The display device may include a first display device and a second display device. In this case, the display layout change step includes moving, among display objects which are displayed on the first display device, the display object, which is extracted at the display object priority comparison step, onto the second display device, and obtaining, as an area for displaying the new window which is requested to be displayed, an area on the first display device where the display object, which is moved onto the second display device, is displayed before being moved.

The display layout change step may includes: when the display request of the new window is received at the window operation request reception step and a plurality of display objects are displayed on the display device, switching display positions of the plurality of display objects so that areas of display objects each having a low display priority are located adjacent to each other; and setting the areas of the switched display objects each having the low display priority to be a single area having a low display priority, and obtaining the single area as an area for displaying the new window which is requested to be displayed.

The above method may further comprise a display item size comparison step of, when the display request of the new window is received at the window operation request reception step, comparing a size of the object having the low display priority, which is extracted at the display object priority comparison step, with a size of the new window, which is requested to be displayed. In this case, the display layout change step includes: when it is determined at the display item size comparison step that the size of the new window, which is requested to be displayed, is larger than that of the object having the low display priority, which is extracted at the display object priority comparison step, and a plurality of display objects are displayed on the display device, switching display positions of the plurality of display objects so that areas of display objects each having a low display priority are located adjacent to each other; and setting the areas of the switched display objects each having the low display priority to be a single area having a low display priority, and obtaining the single area as the area for displaying the new window which is requested to be displayed.

Further, the present invention is directed to an integrated circuit of a multi-window display apparatus for concurrently displaying a plurality of windows. To achieve the above objects, the multi-window display apparatus includes a display device capable of displaying the plurality of windows. Also, the integrated circuit comprises: a display object information management section for managing positions, sizes, and priorities of display objects, which are displayed on the display device; a window operation request reception section for receiving a display request of a new window; a display object priority comparison section for comparing, based on priority, the display objects which are managed by the display object information management section, and extracting a display object having a low display priority; and a new window display position determination section for, when the window operation request reception section receives the display request of the new window, obtaining, as an area having a low display priority, a display area of the display object which is extracted by the display object priority comparison section, and determining a display position of the new window, which is requested to be displayed, to be set on the obtained area.

### EFFECT OF THE INVENTION

According to the multi-window display apparatus of the present invention, when a new window is displayed, an area which can be covered and an area which is not desired to be covered are determined as appropriate. Even when a plurality of windows is displayed concurrently, the visibility for the user can be prevented from being lowered.

### BRIEF DESCRIPTION OF THE DRAWINGS

FIG. 1 is a block diagram showing an exemplary configuration of a multi-window display apparatus according to an embodiment 1 of the present invention.

FIG. 2 shows an example of object information managed by a display object information management section according to the embodiment 1 of the present invention.

FIG. 3 is a flow chart showing an example of an operation of the multi-window display apparatus according to the embodiment 1 of the present invention.

FIG. 4 shows a concrete example when the multi-window display apparatus according to the embodiment 1 of the present invention is applied to a mobile phone.

FIG. 5 is a block diagram showing an exemplary configuration of a multi-window display apparatus according to an embodiment 2 of the present invention.

FIG. 6 shows a concrete example when the multi-window display apparatus according to the embodiment 2 of the present invention is applied to a mobile phone.

FIG. 7 shows a concrete example when the multi-window display apparatus according to the embodiment 2 of the present invention is applied to a mobile phone.

FIG. 8 is a block diagram showing an exemplary configuration of a multi-window display apparatus according to an embodiment 3 of the present invention.

FIG. 9 is a flow chart showing an example of processing of the multi-window display apparatus according to the embodiment 3 of the present invention.

### DESCRIPTION OF THE REFERENCE CHARACTERS

101 window operation request reception section
102 new window display position determination section
103 display object priority comparison section
104 display object information management section
105 display device control section
106 display device
401 screen of display device
402 window of application
403 window of application
404 window of application
405 screen of display device
406 screen of display device
501 display layout change section
601 screen of display device
602 window of application
603 window of application
604 window of application
605 screen of display device
701 screen of display device
702 window of application
703 window of application
704 window of application
705 window of application
801 display item size comparison section

### BEST MODE FOR CARRYING OUT THE INVENTION

### Embodiment 1

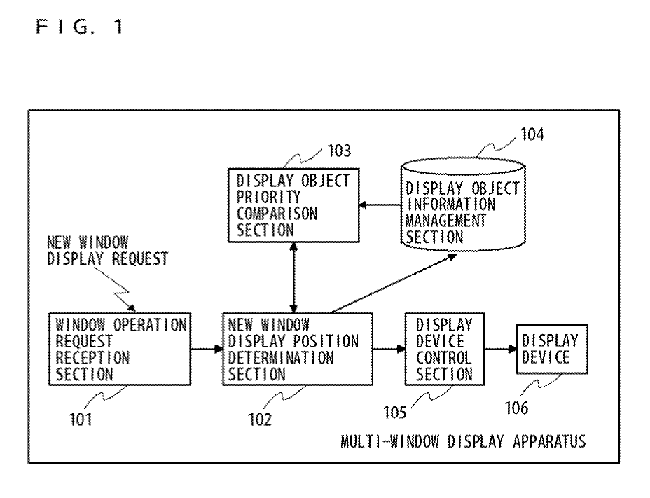

FIG. 1 is a block diagram showing an exemplary configuration of a multi-window display apparatus according to an embodiment 1 of the present invention. As shown in FIG. 1, the multi-window display apparatus includes a window operation request reception section 101, a new window display position determination section 102, a display object priority comparison section 103, a display object information management section 104, a display device control section 105, and a display device 106. The window operation request reception section 101 receives a display request of a new window, which is caused by a predetermined operation which a user performs with an input device such as a key, a mouse, and the like, by an event from the outside the device, such as an incoming telephone call, an incoming e-mail, and the like, or by an instruction which is issued by an application and executed within the multi-window display apparatus. Also, the window operation request reception section 101 transmits information of the new window, which is requested to be displayed, to the new window display position determination section 102. Here, the information of the window includes a display position, a size, and the like.

The new window display position determination section 102 inquires of the display object priority comparison section 103 about an area having a low display priority on the display device 106, and sets a position of the new window, which is requested to be displayed, so as to be superimposed on the area having the low display priority, of which information is received from the display object priority comparison section 103, without protruding therefrom. The new window display position determination section 102 registers the position of the new window in the display object information management section 104, and instructs the display device control section 105 to display the new window. Here, when the new window is large so that it is impossible to superimpose the new window on the area having the low display priority without protruding therefrom, the new window display position determination section 102 may set the position of the new window so as to reduce an area of a portion of the new window protruding from the area having the low display priority as much as possible.

The display object priority comparison section 103 refers to the display object information management section 104, extracts an object having a low display priority, and informs the new window display position determination section 102 of a position of the object having the low display priority as the area having the low display priority. Here, the object includes a window, an icon, a button, a character string, a screen image, and the like, which are displayed on the display device 106.

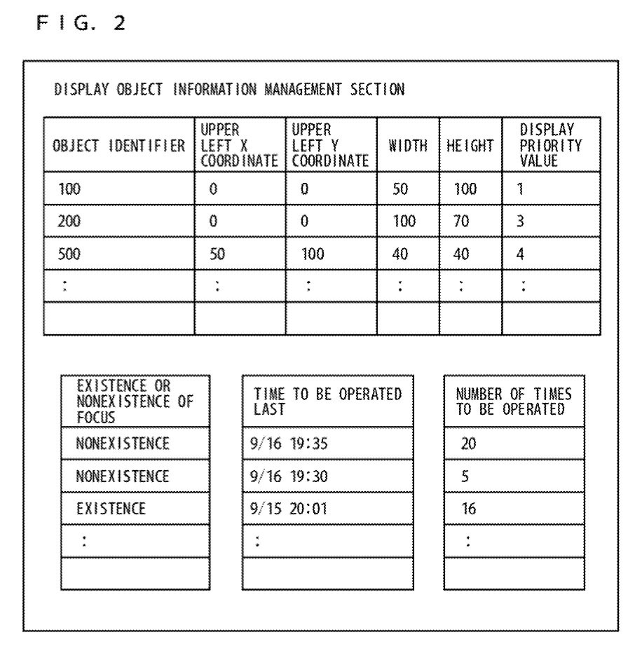

The display object information management section 104 stores information of objects which are displayed on the display device 106. FIG. 2 shows an example of the information of the objects managed by the display object information management section 104. As shown in FIG. 2, the display object information management section 104 manages the information of the objects such as object identifiers, upper left X coordinates of the objects, upper left Y coordinates of the objects, widths of the objects, heights of the objects, values of display priorities of the objects (hereinafter, referred to as display priority values), and the like. The information of the objects may include, in addition to the above information, any information such as existence or nonexistence of a focus, time and date when each object is operated last, a number of times which each object is operated, and the like as long as the information relates to the object. In addition, the display object information management section 104 does not have to manage all of the above information of the objects, and manages at least one piece of the information.

The display device control section 105 receives the display instruction of the new window from the new window display position determination section 102, and displays the new window on the display device 106. Here, the display device 106 is, for example, a display device such as a CRT display, a liquid crystal display, an organic EL display, and the like,

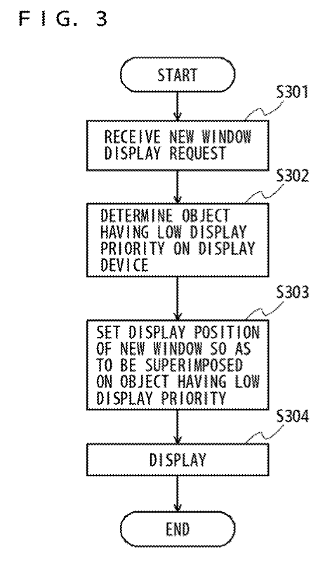

FIG. 3 is a flow chart showing an example of an operation of the multi-window display apparatus according to the embodiment 1 of the present invention. Referring to FIG. 3, when the window operation request reception section 101 receives a display request of a new window by an operation of the user, by a request from a system, by a request from an application which is being executed, or by the like (a step S301), the window operation request reception section 101 transmits information of the window, which is newly requested to be displayed, to the new window display position determination section 102.

The new window display position determination section 102, which has received the information from the window operation request reception section 101, inquires of the display object priority comparison section 103 about an area having a low display priority on the display device 106. Here, only in a case where a number of objects, of which information are registered in the display object information management section 104, is equal to or larger than a constant number when the new window display position determination section 102 receives the information from the window operation request reception section 101, the new window display position determination section 102 may inquire of the display object priority comparison section 103. In other words, in a case where the number of objects, of which information are registered in the display object information management section 104, is not equal to or larger than the constant number, the new window display position determination section 102 may instruct the display device control section 105 to perform a display according to the display request, without modification.

The display object priority comparison section 103, which has received the inquiry from the new window display position determination section 102, refers to the display object information management section 104, and determines an object having a low display priority (a step S302). Here, the determination of the priority is made based on information which is stored in the display object information management section 104. Simply, the display object priority comparison section 103 can determine the object having the low display priority based on a magnitude relation between display priority values which are stored in the display object information management section 104. However, the display priority values themselves do not have to be stored in the display object information management section 104. In other words, the display object priority comparison section 103 may use any values, which are stored in the display object information management section 104, for the determination of the display priority. Alternatively, any values may be used in combination. For example, the display object priority comparison section 103 may determine as the object having the low display priority, among objects each having no display priority value, an object which is operated by the user at the oldest time, or an object which is operated the fewest times.

Still alternatively, the display object priority comparison section 103 may determine the object having the low display priority based on existence or nonexistence of a focus. For example, the display object priority comparison section 103 determines an object having no focus as the object having the low display priority. Still alternatively, the display object priority comparison section 103 may determine as the object having the low display priority, among objects each having no focus, an object which is operated by the user at the oldest time, or an object which is operated the fewest times. Still alternatively, the display object priority comparison section 103 may determine as the object having the low display priority, among objects each having no display priority and no focus, an object which is operated by the user at the oldest time, or an object which is operated the fewest times.

The display object priority comparison section 103, which has determined the object having the low display priority, transmits position information of the object having the low display priority to the new window display position determination section 102. The new window display position determination section 102, which has received the position information of the object having the low display priority, sets a display position of the window, which is newly requested to be displayed, so as to superimpose the window on the object, of which the position information has been received, without protruding therefrom (a step S303), registers window information of the window, which is newly requested to be displayed, in the display object information management section 104, and instructs the display device control section 105 to display the new window. Here, when the window, which is newly requested to be displayed, is larger than the object having the low display priority so that it is impossible to superimpose the window, which is newly requested to be displayed, on the object having the low display priority without protruding therefrom, the display position of the window, which is newly requested to be displayed, may be set so that when the window is superimposed on the object having the low display priority, an area of a protruding portion becomes small. Also, when the window, which is newly requested to be displayed, is smaller than the object having the low display priority, the window, which is newly requested to be displayed, may be positioned after being enlarged so as to cover the object having the low display priority.

The display device control section 105, which has received the display instruction from the new window display position determination section 102, displays the window, which is instructed to be displayed, on the display device 106, and terminates the processing (a step S304).

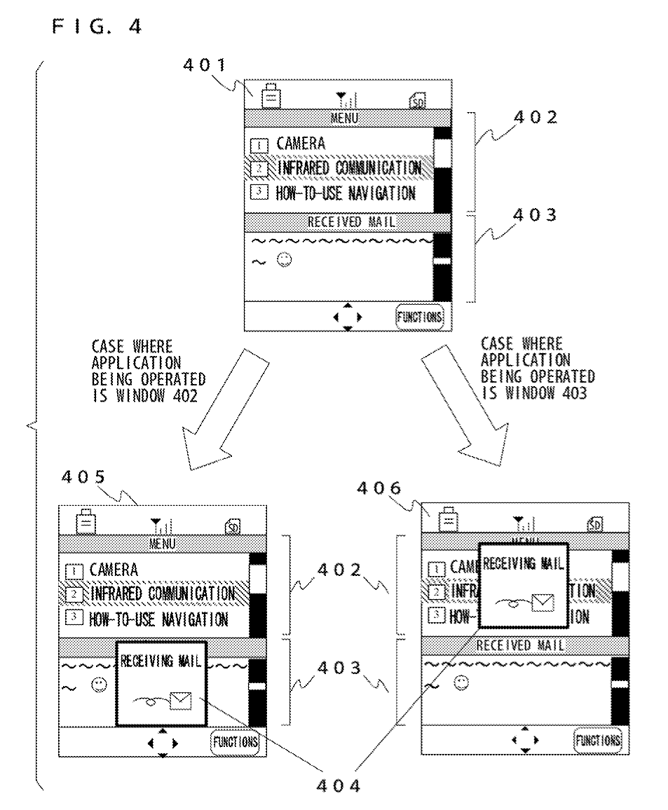

FIG. 4 shows a concrete example when the multi-window display apparatus according to the embodiment 1 of the present invention is applied to a mobile phone. In the example shown in FIG. 4, in a state where windows of two different applications, namely, a window 402 of a menu application and a window 403 of a received mail browsing application, are displayed on a screen 401 of the display device 106, a window 404 for informing the user that an e-mail is being received is displayed.

Referring to FIG. 4, as a method of determining a display priority of a display object, the multi-window display apparatus of the present embodiment determines that a window of an application, which is being operated, has a high display priority, and that a window of an application, which is not being operated, has a low display priority. More specifically, in a case where the window of the application being operated by the user is the window 402 in a state of the screen 401 immediately before an e-mail is received, the multi-window display apparatus of the present embodiment determines that the window 403 of the application, which is not being operated, has a low display priority, and displays the window 404 for informing the user that the e-mail is being received so as to be superimposed on the window 403 (see a screen 405).

On the other hand, in a case where the window of the application being operated by the user is the window 403 in the state of the screen 401 immediately before the e-mail is received, the multi-window display apparatus of the present embodiment determines that the window 402 of the application, which is not being operated, has a low display priority, and displays the window 404 for informing the user that the e-mail is being received so as to be superimposed on the window 402 (see a screen 406).

As described above, when a new window is displayed on the display device 106 on which windows have already been displayed, the multi-window display apparatus according to the embodiment 1 of the present invention searches for an area having a low display priority from information of the existing windows such as a display priority value, existence or nonexistence of a focus, and the like, and displays the new window so as to be superimposed, on the area having the low display priority. This can prevent visibility for the user from being lowered.

### Embodiment 2

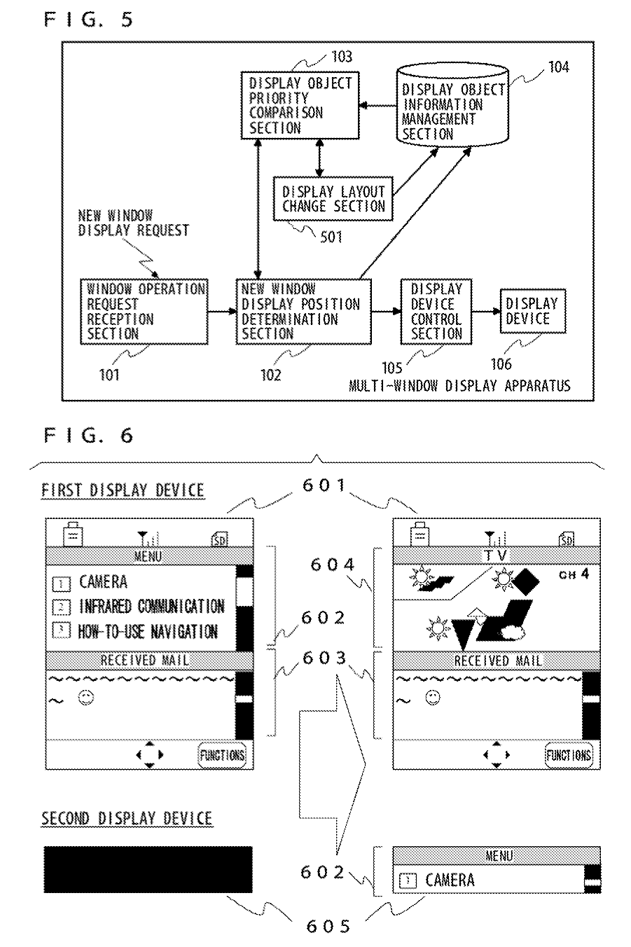

FIG. 5 is a block diagram showing an exemplary configuration of a multi-window display apparatus according to an embodiment 2 of the present invention. It is noted that the same components as those of the embodiment 1 shown in FIG. 1 are designated by the same reference characters, and the description thereof will be omitted.

As shown in FIG. 5, the multi-window display apparatus according to the embodiment 2 of the present invention is different from the multi-window display apparatus according to the embodiment 1 in further including a display layout change section 501. After receiving information of an object having a low display priority, which is extracted by a display object priority comparison section 103, the display layout change section 501 changes a position of the object, and registers changed information in a display object information management section 104. The display object priority comparison section 103 informs the new window display position determination section 102 of an area having a low display priority, which is newly obtained after the position change of the object.

Here, the change of the display position of the object, which is mage by the display layout change section 501, includes, for example, switching an object having a low display priority and an object having a high display priority, changing positions of the objects so that the plurality of objects each having the low display priority are located adjacent to each other when there are a plurality of objects each having a low display priority, moving an object having a low display priority from a display device, on which the object has been displayed, to a different display device, and the like.

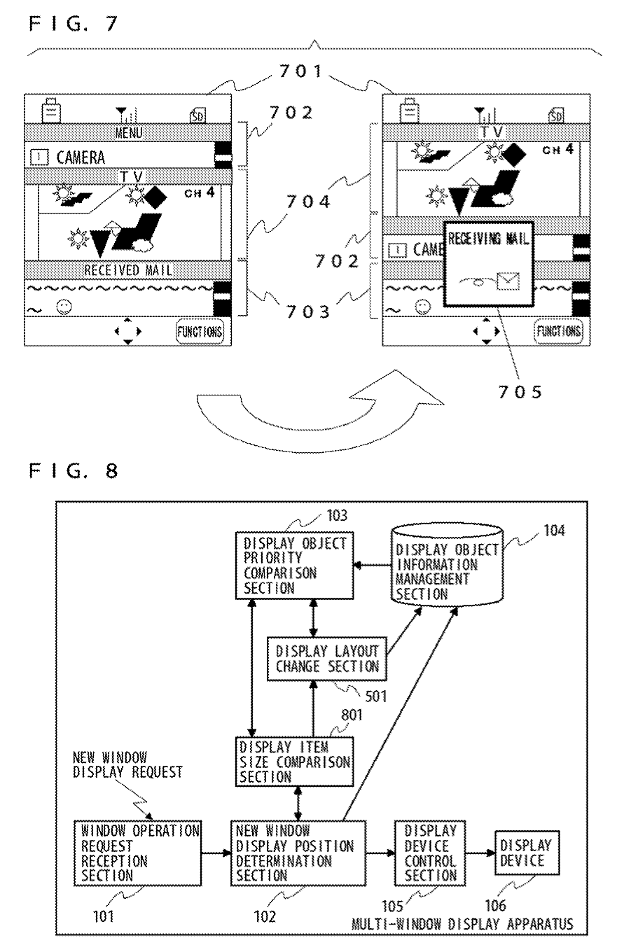

FIGS. 6 and 7 each show a concrete example when the multi-window display apparatus according to the embodiment 2 of the present invention is applied to a mobile phone. In the example shown in FIG. 6, there are two display devices, and in a state where windows of two different applications, namely, a window 602 of a menu application and a window 603 of a received mail browsing application, are displayed on a screen 601 of a first display device, a window 604 of a TV viewing application, which is a different application, is further displayed.

Here, the window 602 of the menu application is assumed to be determined to have a display priority lower than that of the window 603 of the received mail browsing application. Under the above condition, when newly displaying the window 604 of the TV viewing application, the multi-window display apparatus of the present embodiment displays the window 602 of the menu application having the low display priority on a screen 605 of a second display device, and the window 604 of the TV viewing application in an area on the first display device where the window 602 of the menu application has been displayed.

It is noted that when the window 602 of the menu application is displayed on the screen 605 of the second display device, processing of turning on the second display device, lighting a backlight, or the like may be executed concurrently.

In the example shown in FIG. 7, in a mobile phone equipped with the multi-window display apparatus of the present invention, in a state where windows of three different applications, namely, a window 702 of a menu application, a window 703 of a received mail browsing application, and a window 704 of a TV viewing application, are displayed on a screen 701 of a display device, a window 705 for informing the user that an e-mail is being received is displayed.

Here, the window 702 of the menu application and the window 703 of the received mail browsing application are assumed to be determined to have display priorities lower than that of the window 704 of the TV viewing application. Also, the window 702 of the menu application and the window 703 of the received mail browsing application, each of which has the low display priority, are assumed not to be located, adjacent to each other. Under the above conditions, when newly displaying the window 705 for informing the user that the e-mail is being received, the multi-window display apparatus of the present embodiment changes positions of the windows on the screen 701 so that the window 702 of the menu application and the window 703 of the received mail browsing application, each of which has the low display priority, are located adjacent to each other, and newly displays the window 705 for informing the user that the e-mail is being received in adjacent areas each having the low display priority.

It is noted, that the multi-window display apparatus of the present embodiment is capable of displaying every window in addition to the examples described above as a window to be displayed on a screen. For example, the multi-window display apparatus may display, as a new window, a window for indicating a message from a schedule, a window for indicating various alarms, a window for informing that a telephone call (including a TV telephone call) is being received, and a window for indicating any push message.

As described above, when displaying a new window on the display device on which windows have already been displayed, the multi-window display apparatus of the present invention moves an area having a low display priority to obtain a new area having a low display priority, and displays the new window so as to be superimposed on the obtained area having the low display priority. This can prevent the visibility for the user from being lowered.

### Embodiment 3

FIG. 8 is a block diagram showing an exemplary configuration of a multi-window display apparatus according to an embodiment 3 of the present invention. As shown in FIG. 8, the multi-window display apparatus according to the embodiment 3 is different from the multi-window display apparatus according to the embodiment 2 in further including a display item size comparison section 801.

The display item size comparison section 801 obtains information of a window, which is newly requested to be displayed, from a new window display position determination section 102, and also obtains information of an object having a low display priority, which is extracted by a display of object priority comparison section 103. When the object having the low display priority is larger than the window, which is newly requested to be displayed, so that it is possible to superimpose the window, which is newly requested to be displayed, on the object having the low display priority without protruding therefrom, the display item size comparison section 801 instructs a display layout change section 501 not to change a position of the object. On the other hand, when the object having the low display priority is smaller than the window, which is newly requested to be displayed, so that it is impossible to superimpose the window, which is newly requested to be displayed, on the object having the low display priority without protruding therefrom, the display item size comparison section 801 instructs the display layout change section 501 to change the position of the object.

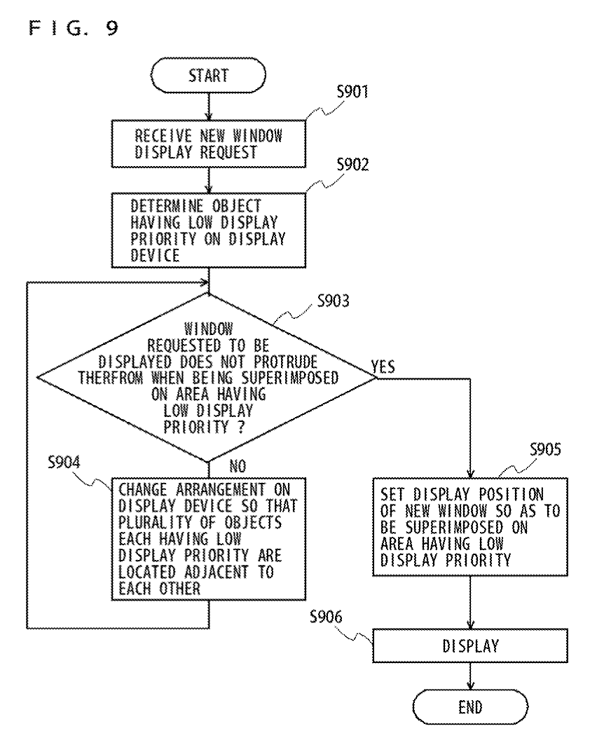

FIG. 9 is a flow chart showing an example of an operation of the multi-window display apparatus according to the embodiment 3 of the present invention. When a window operation request reception section 101 receives a display request of a new window by an operation of the user, by a request from a system, by a request from an application which is being executed, or by the like (a step S901), the window operation request reception section 101 transmits information of the window, which is newly requested to be displayed, to the new window display position determination, section 102.

The new window display position determination section 102, which has received the information from the window operation request reception section 101, transmits the information of the window, which is newly requested to be displayed, to the display item size comparison section 801. The display item size comparison section 801, which has received the information of the window which is newly requested to be displayed, inquires of the display object priority comparison section 103 about an area having a low display priority on a display device 106.

The display object priority comparison section 103, which has received the inquiry from the display item size comparison section 801, refers to a display object information management section 104, and determines an object having a low display priority (a step S902). The display object priority comparison section 103, which has determined the object having the low priority, transmits information of a size and a position of the object having the low priority to the display layout change section 501.

Since the display layout change section 501 has not received an instruction to change a layout from the display item size comparison section 801, the display layout change section 501 transmits information of the area having the low display priority to the display item size comparison section 801 without changing the layout. The display item size comparison section 801 compares a size of the window, which is newly requested to be displayed and of which the information has been received from the new window display position determination section 102, with a size of the area having the low display priority, of which the information has been received from the display layout change section 501 (a step S903). Here, when the size of the area having the low display priority is smaller than that of the window, which is newly requested to be displayed, so that it is impossible to superimpose the window, which is newly requested to be displayed, on the area having the low display priority without protruding therefrom (in the case of NO at the step S903), the display item size comparison section 801 instructs the display layout change section 501 to change the layout so as to enlarge the area having the low priority.

The display layout change section 501, which has received the instruction to change a display layout from the display item size comparison section 801, changes the layout so as to enlarge the area having the low display priority if it is possible to enlarge the area having the low display priority by changing the layout (a step S904), registers changed information in the display object information management section 104, and informs the display item size comparison section 801 of a newly obtained area having a low display priority.

Here, a condition, which makes it possible to enlarge the area having the low display priority by changing the layout, is, for example, that there are a plurality of objects which are determined by the display object priority comparison section 103 to have low display priorities and these objects are not located adjacent to each other. At this time, a wide area having a low display priority can be obtained by changing the layout so that the objects each having the low display priority are located adjacent to each other.

Similarly as above, the display item size comparison section 801, which has received the information of the area having the low display priority, repeats processing such as comparing the size of the window, which is newly requested to be displayed and of which the information has been received from the new window display position determination section 102, with the size of the area having the low display priority, of which the information has been received from the display layout change section 501, until it becomes possible to superimpose the window, which is newly requested to be displayed, on the area having the low display priority without protruding therefrom (until YES at the step S903). It is noted that a condition for the repeat may be not necessarily until it becomes possible to superimpose the window, which is newly requested to be displayed, on the area having the low display priority without protruding therefrom. For example, a number of times of layout change may be limited to a certain number for the condition for the repeat, or the processing may be terminated at a time when all combinations of layout changes are performed. At this time, when the window, which is newly requested to be displayed, is larger than the object having the low display priority so that it is impossible to superimpose the window, which is newly requested to be displayed, on the object having the low display priority without protruding therefrom, the position of the window, which is newly requested to be displayed, may be set so that when the window is superimposed on the object having the low display priority, a area of a protruding portion becomes small.

Alternatively, when the window, which is newly requested to be displayed, is larger than the object having the low display priority so that it is impossible to superimpose the window, which is newly requested to be displayed, on the object having the low display priority without protruding therefrom, the display item size comparison section 801 may enlarge the new window, and position the enlarged new window so as to cover the object having the low display priority. Thus, the new window covers the object having the low display priority, and a number of windows being displayed can be reduced.

When it is possible to superimpose the window, which is newly requested to be displayed, on the area having the low display priority without protruding therefrom (YES at the step S903), the display item size comparison section 801 transmits position information of the area having the low display priority to the new window display position determination section 102. The new window display position determination section 102, which has received the position information of the area of display objects having the low display priority, sets a display position of the window, which is newly requested to be displayed, so as to be superimposed on the area of display objects, of which the position information has been received (a step S906), registers window information of the window, which is newly requested to be displayed, in the display object information management section 104, and instructs the display device control section 105 to display the new window.

The display device control section 105, which has received the display instruction from the new window display position determination section 102, displays the window, which is instructed to be displayed, on the display device 106, and terminates the processing (a step S907).

Although the multi-window display apparatus is described in the embodiment of the present invention, the present invention may be embodied as an integrated circuit. Alternatively, in the embodiment of the present invention, information in the display object information management section 104 may be stored before being changed by the display layout change section 501, and returned when the window, which is newly requested to foe displayed, is closed.

Alternatively, in the embodiment of the present invention, when the size of the window, which is newly requested to be displayed, is larger than that of the area having the low display priority so that it is impossible to superimpose the window, which is newly requested to be displayed, on the area having the low display priority without protruding therefrom, the size of the window, which is newly requested to be displayed, may be reduced to such a size as to superimpose the window on the area having the low display priority without protruding therefrom. In the embodiment of the present invention, a window is used as a concrete example, but, for example, an object to be positioned within a window, and the like may be used instead of the window.

Alternatively, the display object priority comparison section 103 may determine a display priority based on a relation between each object, which is stored in the display object information management section 104, and the window, which is newly requested to be displayed. For example, a display priority of a window of an application, which is the same as an application being operated, is set high.

As described above, when displaying a new window on the display device on which windows have already been displayed, the multi-window display apparatus of the present invention obtains another area having a low display priority by moving an area having a low display priority, and the like in accordance with display contents, and displays the new window so as to be superimposed on the obtained area having the low display priority. This can prevent the visibility for the user from being lowered.

It is noted that each processing, which is executed by the multi-window display apparatuses according to the above-mentioned embodiments 1 to 3, may be realized by a CPU interpreting predetermined program data, which allows the above processing to be executed and which is stored in a memory unit (a ROM, a RAM, a hard disc, and the like). In this case, the program data may be introduced into the memory unit through a storage medium, or may be executed directly from the storage medium. The storage medium includes a semiconductor memory such as a ROM, a RAM, a flash memory, and the like, a magnetic memory such as a flexible disc, a hard disc, and the like, an optical disc memory such as a CD-ROM, a DVD, a BD, and the like, a memory card, and the like. The storage medium also has a concept including a communication medium such as a telephone line, a carrying path, and the like.

It is noted that each component of the multi-window display apparatuses according to the embodiments 1 to 3 other than the display device is typically achieved as an LSI which is an integrated circuit. They may be individually made into one chip, or a part or all of them may be made into one chip. Although the LSI is described here, the integrated circuit is referred to as an IC, a system LSI, a super LSI, an ultra LSI depending on difference in integration degrees.

A technique of integrated circuit implementation is not limited to the LSI, but may be achieved by a dedicated circuit or at universal processor. An FPGA (Field Programmable Gate Array) which is programmable after production of an LSI and a reconfigurable processor in which the connection and the setting of a circuit cell inside the LSI are reconfigurable may be used. Further, if a technique of integrated circuit implementation which replaces the LSI by advancement of semiconductor technique or another technique derived therefrom is developed, naturally, function blocks may be integrated by using the technique. Adaptation of a bio technique could be possible.

### INDUSTRIAL APPLICABILITY

The multi-window display apparatus according to the present invention is used in an electronic apparatus having a display device, and the like, and especially, useful for an apparatus having a small display device, such as a mobile phone, a digital camera, a car navigation system, and the like.

1. A multi-window display apparatus for concurrently displaying a plurality of windows, the multi-window display apparatus comprising:
a display device capable of displaying the plurality of windows;
a display device control section for controlling an operation of the display device;
a display object information management section for managing positions, sizes, and priorities of display objects, which are displayed on the display device;
a window operation request reception section for receiving a display request of a new window;
a display object priority comparison section for comparing, based on priority, the display objects which are managed by the display object information management section, and extracting a display object having a low display priority; and
a new window display position determination section for, when the window operation request reception section receives the display request of the new window, obtaining, as an area having a low display priority, a display area of the display object which is extracted by the display object priority comparison section, and determining a display position of the new window, which is requested to be displayed, to be set on the obtained area.

2. The multi-window display apparatus according to claim 1, further comprising a display layout change section for changing a display layout of the display object, which is extracted by the display object priority comparison section, so as to obtain a display area of the new window, which is requested to be displayed, wherein
the new window display position determination section determines the display position of the new window, which is requested to be displayed, to be set on the display area which is obtained by the display layout change section.

3. The multi-window display apparatus according to claim 2, wherein
the display device includes a first display device and a second display device,
the display layout change section moves, among display objects which are displayed on the first display device, the display object, which is extracted by the display object priority comparison section, onto the second display device, and obtains, as an area for displaying the new window which is requested to be displayed, an area on the first display device where the display object, which is moved onto the second display device, is displayed before being moved.

4. The multi-window display apparatus according to claim 2, wherein when the window operation request reception section receives the display request of the new window and a plurality of display objects are registered in the display object information management section, the display layout change section switches display positions of the plurality of display objects so that areas of display objects each having a low display priority are located adjacent to each other, sets the areas of the switched display objects each having the low display priority to be a single area having a low display priority, and obtains the single area as an area for displaying the new window which is requested to be displayed.

5. The multi-window display apparatus according to claim 4, further comprising a display item size comparison section for, when the window operation request reception section receives the display request of the new window, comparing a size of the object having the low display priority, which is extracted by the display object priority comparison section, with a size of the new window, which is requested to be displayed, wherein
when it is determined by the display item size comparison section that the size of the new window, which is requested to be displayed, is larger than that of the object having the low display priority, which is extracted by the display object priority comparison section, and a plurality of display objects are registered in the display object information management section, the display layout change section switches display positions of the plurality of display objects so that areas of display objects each having a low display priority are located adjacent to each other, sets the areas of the switched display objects each having the low display priority to be a single area having a low display priority, and obtains the single area as the area for displaying the new window which is requested to be displayed.

6. The multi-window display apparatus according to claim 1, wherein the display objects which are displayed on the display device are windows.

7. A multi-window display method for concurrently displaying a plurality of windows on a display device, the multi-window display method comprising:
a window operation request reception step of receiving a display request of a new window;
a display object priority comparison step of, when receiving the display request of the new window, comparing, based on priority, display objects which are displayed on the display device, and extracting a display object having a low display priority;
a new window display position determination step of obtaining, as an area having a low display priority, a display area of the display object which is extracted at the display object priority comparison step, and determining a display position of the new window, which is requested to be displayed, to be set on the obtained area; and
a display device control step of controlling an operation of the display device so as to display the new window in the display position which is determined at the new window display position determination step.

8. The multi-window display method according to claim 7, further comprising a display layout change step of changing a display layout of the display object, which is extracted at the display object priority comparison step, so as to obtain a display area of the new window which is requested to be displayed, wherein
the new window display position determination step includes determining the display position of the new window, which is requested to be displayed, to be set on the display area which is obtained at the display layout change step.

9. The multi-window display method according to claim 8, wherein
the display device includes a first display device and a second display device,
the display layout change step includes moving, among display objects which are displayed on the first display device, the display object, which is extracted at the display object priority comparison step, onto the second display device, and obtaining, as an area for displaying the new window which is requested to be displayed, an area on the first display device where the display object, which is moved onto the second display device, is displayed before being moved.

10. The multi-window display method according to claim 8, wherein
the display layout change step includes:
when the display request of the new window is received at the window operation request reception step and a plurality of display objects are displayed on the display device, switching display positions of the plurality of display objects so that areas of display objects each having a low display priority are located adjacent to each other; and
setting the areas of the switched display objects each having the low display priority to be a single area having a low display priority, and obtaining the single area as an area for displaying the new window which is requested to be displayed.

11. The multi-window display method according to claim 10, further comprising a display item size comparison step of, when the display request of the new window is received at the window operation request reception step, comparing a size of the object having the low display priority, which is extracted at the display object priority comparison step, with a size of the new window, which is requested to be displayed, wherein
the display layout change step includes:
when it is determined at the display item size comparison step that the size of the new window, which is requested to be displayed, is larger than that of the object having the low display priority, which is extracted at the display object priority comparison step, and a plurality of display objects are displayed on the display device, switching display positions of the plurality of display objects so that areas of display objects each having a low display priority are located adjacent to each other; and
setting the areas of the switched display objects each having the low display priority to be a single area having a low display priority, and obtaining the single area as the area for displaying the new window which is requested to be displayed.

12. The multi-window display method according to claim 7, wherein the display objects which are displayed on the display device are windows.

13. An integrated circuit of a multi-window display apparatus for currently displaying a plurality of windows,
the multi-window display apparatus including a display device capable of displaying the plurality of windows,
the integrated circuit comprising:
a display object information management section for managing positions, sizes, and priorities of display objects, which are displayed on the display device;
a window operation request reception section for receiving a display request of a new window;
a display object priority comparison section for comparing, based on priority, the display objects which are managed by the display object information management section, and extracting a display object having a low display priority; and
a new window display position determination section for, when the window operation request reception section receives the display request of the new window, obtaining, as an area having a low display priority, a display area of the display object which is extracted by the display object priority comparison section, and determining a display position of the new window, which is requested to be displayed, to be set on the obtained area.
